(19) United States
(12) Patent Application Publication
(10) Pub. No.: US 2026/0309828 A1
(43) Pub. Date: Oct. 8, 2026

(54) REPORTING POSITIONING MEASUREMENTS

(71) Applicant: Lenovo (Singapore) Pte. Ltd., Singapore (SG)

(72) Inventors: Robin Thomas, Bad Nauheim (DE); Karthikeyan Ganesan, Nauheim (DE); Ankit Bhamri, Rödermark (DE); Hyejung Jung, Northbrook, IL (US); Vijay Nangia, Woodridge, IL (US); Hossein Bagheri, Dearborn Heights, IL (US); Ravi Kuchibhotla, Chicago, IL (US)

(21) Appl. No.: 19/716,820

(22) Filed: Jun. 23, 2026

Related U.S. Application Data
(63) Continuation of application No. 18/000,181, filed on May 28, 2021, now Pat. No. 12,693,368.
(60) Provisional application No. 63/031,995, filed on May 29, 2020.

(51) Int. Cl. G01S 5/00; G01S 5/02; H04W 64/00

(52) U.S. Cl. CPC G01S 5/0036; G01S 5/0218; G01S 5/0236; H04W 64/00; G01S 2205/008

(57) ABSTRACT

Apparatuses, methods, and systems are disclosed for reporting positioning measurements. One method includes transmitting positioning measurement configuration information including a list of candidate beams, a priority indicator, and reporting criteria for positioning. Each candidate beam of the list of candidate beams may be associated with a positioning reference signal (PRS). The reporting criteria for positioning may include a non-line-of-sight (NLOS) measurement indicator, a line-of-sight (LOS) measurement indicator, and a reporting priority for each candidate beam of the list of candidate beams. The method may include receiving a report of positioning measurements based on the reporting criteria for at least one candidate beam of the list of candidate beams. The positioning measurements may be based on PRSs associated with at least one candidate beam of the list of candidate beams based on an associated PRS configuration.

### FIELD

The subject matter disclosed herein relates generally to wireless communications and more particularly relates to reporting positioning measurements.

### BACKGROUND

In certain wireless communications networks, positioning measurements may be made. In such embodiments, various reports may be made.

### BRIEF SUMMARY

Methods for reporting positioning measurements are disclosed. Apparatuses and systems also perform the functions of the methods. One embodiment of a method includes transmitting positioning measurement configuration information including a list of candidate beams, a priority indicator, and reporting criteria for positioning. Each candidate beam of the list of candidate beams may be associated with a positioning reference signal (“PRS”). The reporting criteria for positioning may include a non-line-of-sight (“NLOS”) measurement indicator, a line-of-sight (“LOS”) measurement indicator, and a reporting priority for each candidate beam of the list of candidate beams. The method may include receiving a report of positioning measurements based on the reporting criteria for at least one candidate beam of the list of candidate beams. The positioning measurements may be based on PRSs associated with at least one candidate beam of the list of candidate beams based on an associated PRS configuration.

A network unit for wireless communication is described. The network unit may be configured to, capable of, or operable to cause the network unit to transmit positioning measurement configuration information including a list of candidate beams, a priority indicator, and reporting criteria for positioning. Each candidate beam of the list of candidate beams may be associated with a PRS. The reporting criteria for positioning may include an NLOS measurement indicator, a LOS measurement indicator, and a reporting priority for each candidate beam of the list of candidate beams. The network unit may be configured to, capable of, or operable to cause the network unit to receive a report of positioning measurements based on the reporting criteria for at least one candidate beam of the list of candidate beams. The positioning measurements may be based on PRSs associated with at least one candidate beam of the list of candidate beams based on an associated PRS configuration.

Another method performed or performable by a network unit is described. The method may include transmitting positioning measurement configuration information including a list of candidate beams, a priority indicator, an NLOS measurement indicator, a LOS measurement indicator, and a reporting priority for each candidate beam of the list of candidate beams. Each candidate beam of the list of candidate beams may be associated with a PRS. The method may include transmitting one or more LOS reporting criteria, or one or more NLOS reporting criteria, or both. The method may include receiving a report of a PRS measurement of at least one beam of the list of candidate beams. The reported PRS measurement may be based on the LOS reporting criteria or the NLOS reporting criteria. The PRS measurement of at least one beam of the list of candidate beams may be based on the positioning measurement configuration information. The report may further indicate whether the PRS measurement is classified as non LOS or LOS by a user equipment (“UE”).

Another network unit for wireless communication is described. The network unit may be configured to, capable of, or operable to cause the network unit to transmit positioning measurement configuration information including a list of candidate beams, a priority indicator, an NLOS measurement indicator, a LOS measurement indicator, and a reporting priority for each candidate beam of the list of candidate beams. Each candidate beam of the list of candidate beams may be associated with a PRS. The network unit may be configured to, capable of, or operable to cause the network unit to transmit one or more LOS reporting criteria, or one or more NLOS reporting criteria, or both. The network unit may be configured to, capable of, or operable to cause the network unit to receive a report of a PRS measurement of at least one beam of the list of candidate beams. The reported PRS measurement may be based on the LOS reporting criteria or the NLOS reporting criteria. The PRS measurement of at least one beam of the list of candidate beams may be based on the positioning measurement configuration information. The report may further indicate whether the PRS measurement is classified as non LOS or LOS by a UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one example of a wireless communication system for reporting positioning measurements.

FIG. 2 is a schematic block diagram illustrating one example of an apparatus that may be used for reporting positioning measurements.

FIG. 3 is a schematic block diagram illustrating one example of an apparatus that may be used for reporting positioning measurements.

FIG. 4 is a table illustrating one example of a UE-based candidate-beam list and/or index using a timing-based criterion.

FIG. 5 is a table illustrating one example of a UE-based measured candidate-beam list and/or index using network configured priority-based criterion.

FIG. 6 is a table illustrating one example of a UE-based measured candidate-beam list and/or index using UE-based configured priority-based criterion.

FIG. 7 is a table illustrating one example of a UE-based measured candidate-beam list and/or index using an LOS and/or NLOS identification.

FIG. 8 is a table illustrating one example rapid switching between different transmission and reception points (“TRPs”).

FIG. 9 is a flow chart diagram illustrating one example of a method for reporting positioning measurements.

FIG. 10 is a flow chart diagram illustrating another example of a method for reporting positioning measurements.

FIG. 11 is a flow chart diagram illustrating one example of a method for requesting positioning measurements.

FIG. 12 is a flow chart diagram illustrating another example of a method for requesting positioning measurements.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable ROM (“EPROM”) or Flash memory, a portable compact disc ROM (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

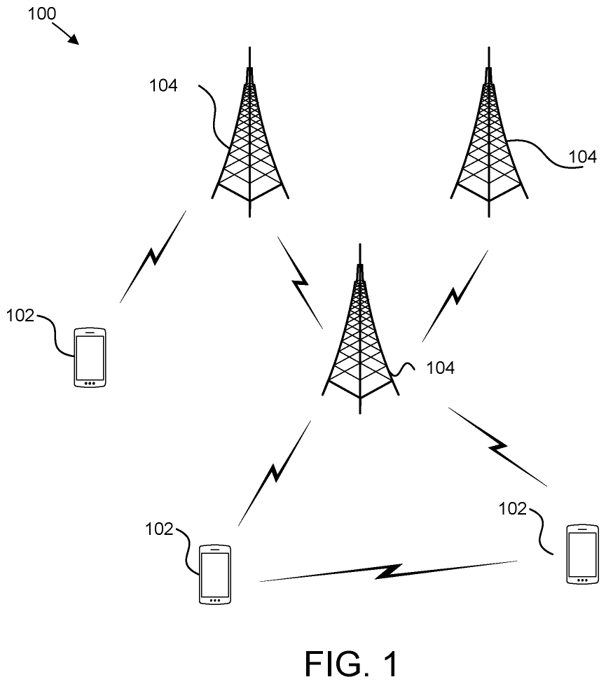

FIG. 1 depicts an embodiment of a wireless communication system 100 for reporting positioning measurements. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an orthogonal frequency division multiplexing (“OFDM”) modulation scheme on the downlink (“DL”) and the remote units 102 transmit on the uplink (“UL”) using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive positioning measurement configuration information including: a list of candidate beams, wherein each candidate beam of the list of candidate beams is associated with a PRS; a priority indicator; a temporal switching criteria; and/or a reporting criteria for positioning. The reporting criteria includes a positioning reference signal received power, an NLOS measurement indicator, a LOS measurement indicator, and/or a reporting priority for each candidate beam of the list of candidate beams. In some embodiments, the remote unit 102 may measure a PRS associated with each candidate beam of the list of candidate beams based on an associated PRS configuration. In certain embodiments, the remote unit 102 may report positioning measurements based on the reporting criteria for at least one candidate beam of the list of candidate beams. Accordingly, the remote unit 102 may be used for reporting positioning measurements.

In certain embodiments, a remote unit 102 may measure a PRS of each candidate beam of a list of candidate beams based on positioning measurement configuration information. In certain embodiments, the remote unit 102 may receive a LOS reporting criteria or an NLOS reporting criteria. In various embodiments, the remote unit 102 may classify the PRS measurement as NLOS or LOS. In some embodiments, the remote unit 102 may report the PRS measurement of at least one beam of the list of candidate beams. The reported PRS measurement is based on the LOS reporting criteria or the NLOS reporting criteria. In certain embodiments, the remote unit 102 may reselect a beam of the list of candidate beams based on the PRS measurement for performing positioning. Accordingly, the remote unit 102 may be used for reporting positioning measurements.

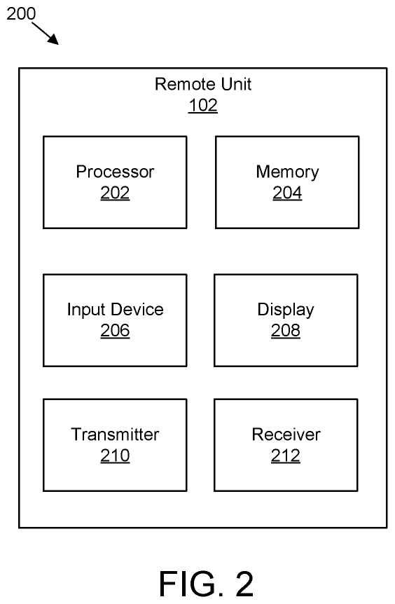

FIG. 2 depicts one embodiment of an apparatus 200 that may be used for reporting positioning measurements. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 receives positioning measurement configuration information including: a list of candidate beams, wherein each candidate beam of the list of candidate beams is associated with a PRS; a priority indicator; a temporal switching criteria; and/or a reporting criteria for positioning. The reporting criteria includes a PRS received power, an NLOS measurement indicator, a LOS measurement indicator, and/or a reporting priority for each candidate beam of the list of candidate beams. In various embodiments, the processor 202: measures a positioning reference signal associated with each candidate beam of the list of candidate beams based on an associated positioning reference signal configuration; and reports positioning measurements based on the reporting criteria for at least one candidate beam of the list of candidate beams.

In some embodiments, the processor 202 measures a positioning reference signal of each candidate beam of a list of candidate beams based on positioning measurement configuration information. In various embodiments, the receiver 212 receives a LOS reporting criteria or an NLOS reporting criteria. In certain embodiments, the processor 202: classifies the positioning reference signal measurement as NLOS or LOS; reports the positioning reference signal measurement of at least one beam of the list of candidate beams, wherein the reported positioning reference signal measurement is based on the LOS reporting criteria or the NLOS reporting criteria; and reselects a beam of the list of candidate beams based on the positioning reference signal measurement for performing positioning.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

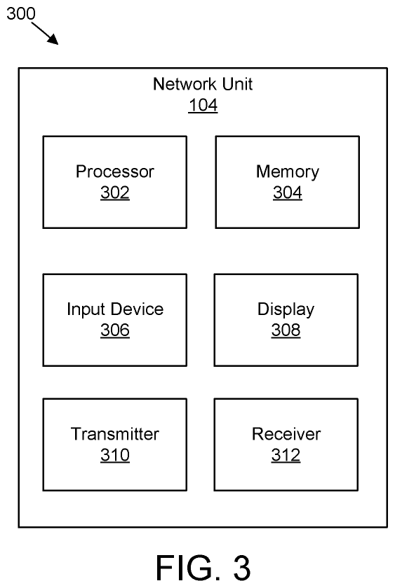

FIG. 3 depicts one embodiment of an apparatus 300 that may be used for reporting positioning measurements. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the apparatus includes transmitting the positioning measurement configuration information to a UE via an LTE positioning protocol (“LPP”). In some embodiments, the reporting priority is associated with one or more of a DL positioning-related signal, a UL positioning-related signal, a DL positioning-related signal identifier (“ID”), a UL positioning-related signal ID, a PRS ID, a sounding reference signal (“SRS”) ID, a PRS resource set, an SRS resource set, or a TRP ID. In various embodiments, the report of positioning measurements is received via a beam from the list of candidate beams based on at least one temporal switching criterion.

In certain embodiments, the beam for the report of positioning measurements includes a beam from a TRP within a set of TRPs distinct from a currently received beam, and each TRP of the set of TRPs maps to a priority indication. In some embodiments, the reporting priority may include a network configured priority transmitted as assistance data to a UE via an LPP. In various embodiments, the apparatus includes receiving the list of candidate beams from a UE as assistance information, where the list of candidate beams includes at least one candidate beam related PRS measurement, the at least one candidate beam related PRS measurement includes one or more of a PRS received power, an NLOS measurement indicator, or a LOS measurement indicator. In various embodiments, the apparatus is a base station or a location management function (“LMF”).

In certain embodiments, target device and/or UE positioning using NR technology may be used. In such embodiments, positioning features may include fifth generation core network (“5GC”) architectural and interface elements, and RAN functionality that supports physical layer and layer 2 and/or layer 3 signaling procedures to enable NR positioning.

In some embodiments NR positioning may be used to facilitate reduced latency and higher reliability positioning. In various embodiments, beam-based positioning through PRS transmission from different TRPs may be performed. In such embodiments, a resulting TRP and/or beam failure may directly affect positioning performance in terms of lowered accuracy and increased latency corresponding to a UE's position estimate.

In certain embodiments, a beam failure, an NLOS beam, and/or a lack of suitable LOS beam may impact positioning-related measurements performed at a UE and may decrease a positioning accuracy required by a location server (e.g., UE-assisted positioning) or at the UE (e.g., UE-based positioning).

In some embodiments, positioning resiliency may be a factory floor or industrial internet of things (“IIoT”) setting used to meet a stringent precision and low latency for various IIoT applications.

In various embodiments, mechanisms may be used to improve latency and reliability of a positioning estimate by performing rapid beam reselection and/or switching using a time-based criteria, priority indications, LOS and/or NLOS indications, and/or positioning error criteria.

In certain embodiments, positioning-related measurements may be defined as measurements of a signal (e.g., PRS or SRS) used for the purpose of performing positioning using certain techniques (e.g., DL time distance of arrival (“TDOA”), angle of departure (“AoD”), multi round trip time (“RTT”) (“multi-RTT”), and so forth).

In some embodiments, a dynamic TRP selection mechanism may be enabled to allow for location services that have flexible accuracy adaptation.

In various embodiments, an efficient method may be used to add beam measurement candidates for increasing an accuracy of a UE's position estimate. Such embodiments may support dynamic accuracy adaptation at the UE.

In certain embodiments, enhanced resiliency and low latency UE positioning may be obtained in relation to beam and TRP reselection for increased positioning performance.

In some embodiments, a mechanism may be used to rapidly select and/or switch to a suitable beam and/or TRP containing positioning-related reference signal (“RS”) transmissions such as PRS after beam failure or NLOS beam detection based on a configured candidate list of beams and TRPs at a UE to maintain or increase UE positioning accuracy during an occurrence of such events. In such embodiments, a configured beam-candidate list may be provided to the UE by a network (e.g., gNB using radio resource control (“RRC”), location server using LPP) or based on a pre-configuration. Moreover, in such embodiments, positioning reference signals for candidate beams may be periodically measured with configurable intervals and based on a timing criteria, a priority indication, and/or an LOS and/or NLOS beam indication of an associated location request and positioning-related RS. In such embodiments, the candidate beams may be periodically updated at the UE and may be used for rapid switching upon beam failure (e.g., activation of a timer, upon detection of physical layer problems in an RRC_Connected state), upon NLOS beam detection, or if no LOS beams are detected. Further, in such embodiments, a timing criteria may be based on a shortest time difference between a time of a failure event on a first beam and a time instance that a measurement of a most suitable RS reference signal received power (“RSRP”) on a second beam (e.g., selected from a candidate-beam) has been completed. Such embodiments may benefit a DL TDOA positioning technique if at least 3 beams belonging to a same TRP and/or different TRPs containing PRS resources are required for reference signal time difference (“RSTD”) measurements (e.g., 1 reference beam together with 2 other beams).

In various embodiments, a rapid and efficient mechanism may be used to avoid beam selection (or reselection) procedures for reliable and low latency positioning. In such embodiments, selected positioning-related RS resources from each beam candidate within a single TRP or set of TRPs to perform positioning related measurements may allow for increased accuracy depending on factors such as a configured positioning-related RS bandwidth of a selected beam candidate.

In certain embodiments, an indoor factory or IIoT environment may increase a likelihood of beam failure due to factors such as link blockage, high probability of NLOS, variability of an indoor environment (e.g., movement of people and objects), clutter density, and variable base station and UE heights. First and second embodiments describe a two-level rapid beam switching mechanism. In the first embodiment, fast beam switching within a configured beam-candidate list may be used. For at least one TRP, there may be a set of candidate beams for PRS transmission. If one of the beams for a given TRP is not suitable for positioning measurements, then a UE may switch a receive (“RX”) beam to receive the PRS from a different beam of the same TRP. In the second embodiment, fast and/or rapid TRP switching for beam-candidates belonging to different TRPs may be used. The second embodiment may comprise both rapid beam and TRP switching and/or reselection. If all the beams for a TRP are exhausted or deemed not suitable for PRS measurement, the UE may switch to another TRP within a set of TRP candidates.

In some embodiments, there may be direct switching of TRPs without going through switching of beams within a TRP (e.g., if there are AoD methods in which location diversity of the TRP may increase either the horizontal accuracy or the vertical accuracy.

Embodiments described herein may facilitate low latency positioning with increased horizontal accuracy and vertical accuracy.

In various embodiments, there may be fast beam switching within a configured-beam candidate list. In certain embodiments, UE-based rapid beam selection and switching mechanisms may be enabled using a timing-based criterion.

In certain embodiments, beam recovery procedures may be divided as follows: 1) beam-failure detection: UE detecting that a beam failure has occurred; 2) candidate beam identification: UE identifying a new suitable beam pair to recover a link and connection; 3) recovery request: UE transmits a recovery request to a network (e.g., serving gNB); and 4) recovery request response: gNB transmits a beam recovery response to the UE.

In some embodiments, in the context of positioning, a beam failure may result in a measurement loss of PRS resources which were initially configured by an LMF. Such beam failure may degrade an original accuracy required before initiating a positioning request. Furthermore, in such embodiments, for positioning techniques such as DL-TDOA, which rely on RSTD measurements between a pair of PRS resources and/or PRS resource sets, beam failure or NLOS beams may contribute to positioning accuracy degradation and a loss of the configured RSTD measurement. Beams which are NLOS to a UE, may need to be reselected since these beams may result in a decrease in accuracy of the UE's position estimate.

In various embodiments, a UE may be allowed to rapidly select a next available beam based on a configured or preconfigured beam-candidate list, which is triggered upon the following events: 1) beam-failure detection containing a positioning-related RS configuration (e.g., activation of a timer, detection of physical problems in an RRC_Connected state); 2) NLOS beam detection containing a positioning-related RS configuration; and 3) being unable to detect a required number of LOS beams containing a positioning-related RS configuration for a positioning technique (e.g., based on a number of an LOS beam threshold parameter).

In certain embodiments, rapid selection may be based on a timing-based criterion defined by: ΔtSwitch_Beam=tBeam_Failure-tRS_RSRP_Beam, where ΔtSwitch_Beam is a time difference between an instance in which beam failure has occurred, (tBeam_Failure)/NLOS beam has been detected (tNLOS_detection) on the first beam, and the instance that the measured PRS RSRP of a second beam from a candidate-beam list preconfigured at a UE has been completed. The UE may consider this specified criterion to perform rapid beam switching in addition to measuring the RSRP. The candidate beam with the shortest ΔtSwitch_Beam and the best corresponding PRS RSRP may then be selected. In some examples, the candidate beam is an LOS beam.

In some embodiment, NLOS beam detection may be detected in the following ways: 1) after any interruption to beam operation, such as if there is a bandwidth part (“BWP”) switch or signal quality degradation, quality degradation of a positioning quality criteria, if more than “X” NLOS beams are detected, or if less than “Y” LOS beams detected (e.g., where “X” and/or “Y” are fixed in a specifications, RRC configured, or a UE capability parameter); 2) if there is any change in a number of configured, activated, and/or released configured grant configurations; and 3) over a periodic interval “T” a beam may be considered NLOS (e.g., a snapshot of time), which may be divided into: a) short term NLOS (e.g., short-term changes in a radio environment may cause NLOS beams, resulting from people and/or objects moving); b) medium term NLOS (e.g., medium-term changes in the radio environment may cause NLOS beams, objects obstructing LOS for a temporary period (e.g., timescale in hours)); c) long term NLOS (e.g., long-term changes in the radio environment may cause NLOS beams, objects obstructing LOS for a long period (e.g., with a timescale in days, weeks, etc.)); and d) may be realized through an activation of a physical layer NLOS beam detection timer which may be configured via RRC.

In various embodiments, in the context of positioning, priority may be primarily given to candidate beams already containing PRS resources. If PRS resources are yet to be configured by an LMF and gNB for beam candidates, RSs to be measured for candidate-beams may include but are not limited to synchronous signal block (“SSB”) and/or physical broadcast channel (“PBCH”), and channel state information reference signals (“CSI-RSs”). Certain radio measurement metrics, such as received signal strength indicator (“RSSI”), may also be considered for creating a beam-candidate list. In certain embodiments, an RSRP may also be measured to be within an RSRP interval, or above or below a configured RSRP threshold to autonomously switch to a most suitable beam from a beam-candidate list.

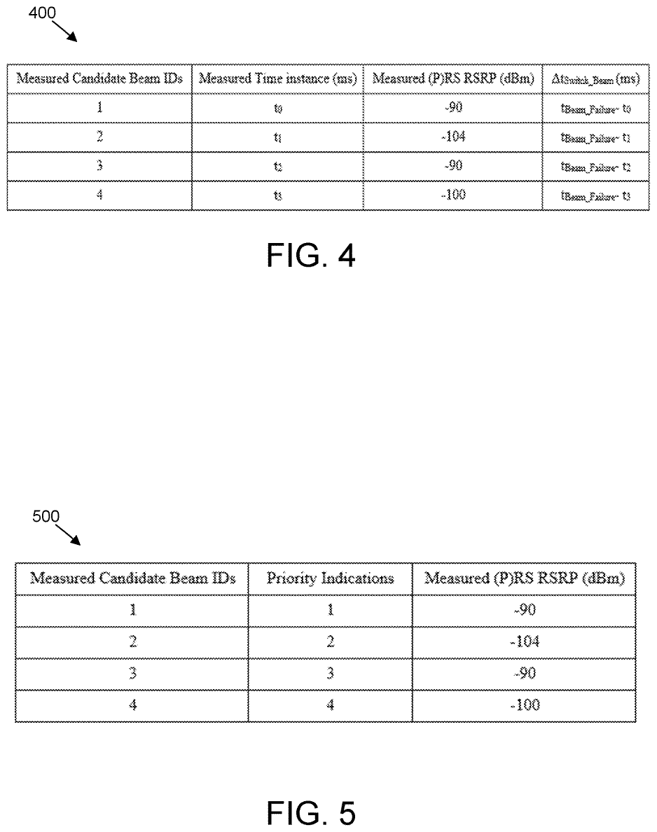

FIG. 4 illustrates one embodiment of a representation of a UE configured or preconfigured candidate-beam list and/or index, where tBeam_Failure-t3<tBeam_Failure-t2<tBeam_Failure-t1<tBeam_Failure-t0. According to FIG. 4, a UE may autonomously switch to candidate beam ID 3 with a strongest respective RSRP and a lowest ΔtSwitch_Beam. Specifically, FIG. 4 is a table 400 illustrating one embodiment of a UE-based candidate-beam list and/or index using a timing-based criterion.

In certain embodiments, a beam ID with a strongest respective RSRP and a lowest ΔtSwitch_Beam may be selected with positioning-related RS (e.g., DL PRS) resources satisfying one or more of the following criteria: 1) having a bandwidth (“BW”) larger than ‘X’ or a BW not smaller than an outdated and/or exhausted beam; 2) being associated with the same BWP and/or positioning frequency layer as the outdated and/or exhausted beam or a similar BWP and/or positioning frequency layer (e.g., a BWP selected from a pair of RRC configured BWPs); and 3) not being associated with a TRP that can serve high priority data transmissions.

In some embodiments, a UE may not be expected to perform multiple (or more than “N”) fast beam switching within a period of time, wherein “N” may be: 1) fixed in a specification; 2) subcarrier spacing (“SCS”) dependent, frequency range dependent, and/or positioning frequency layer dependent; 3) a UE capability; or 4) RRC configured.

In various embodiments, a UE may be configured with a timer that is set if a first fast switching is performed, and a timer value may be decreased per unit of time (e.g., per slot, per DL PRS period).

In certain embodiments, “N” may be different for switching TRPs as compared to switching beams within the same TRP. In some embodiments, there may be a timer for fast beam switching within the same TRP and another timer for fast beam switching across different TRPs.

In various embodiments, a candidate-beam list is periodically updated (e.g., while in an RRC_Connected state, an RRC_IDLE state, an RRC_Inactive state, or during a measurement gap) based on a UE configuration and a serving base station may provide assistance information to the UE regarding all possible beam-candidates for a given TRP in the vicinity of the UE from the serving gNB and neighboring gNBs.

In some embodiments, there may be an application and/or switching time for switching beams or TRPs (e.g., a new set of beams, TRPs, and/or DL PRS sets may be valid after some time after an interruption, failure detection, and/or accuracy update). In such embodiments, the application and/or switching time may depend on one of the following: 1) being specified as a UE capability parameter; 2) being a fixed value in a specifications; 3) being dependent on SCS; or 4) being dependent on a number of TRPs and/or beams.

In various embodiments, a UE may forward a beam-candidate list to an LMF for positioning-related configurations in a ranked priority order based on a timing criteria, ΔtSwitch_Beam, or as assistance information to aid in a calculation of a UE's location estimate.

Certain embodiments described herein may enable a UE to rapidly and autonomously switch and reselect between beams for positioning related measurements in the event of beam failure, NLOS beam detection, or lack of required LOS beams. Such embodiments may lower the probability of degrading a 2D and/or 3D positioning accuracy associated with a set of positioning-related measurements.

In some embodiments, a rapid selection and switching mechanism may enable using a priority-based criterion.

FIG. 5 illustrates one representation of a table 500 of network configured priority-based criterion for selecting a next available beam. In some embodiments, a UE may be allowed to rapidly select a next available beam from a configured or preconfigured beam-candidate list using network configured priority indications. In such embodiments, a rapid reselection and switching mechanism may be based on a network configured priority criterion, e.g., as shown in FIG. 5. Specifically, the table 500 illustrates one embodiment of a UE-based measured candidate-beam list and/or index using the network configured priority-based criterion.

In some embodiments, in the event of beam failure, NLOS detection, and/or lack of suitable LOS beams, a candidate beam with a highest priority and the corresponding PRS RSRP (or PRS RSRP above a threshold) may be selected, where according to FIG. 5, a highest priority is indicated by 1 while a lowest priority is indicated by 4. Therefore, according to FIG. 5, candidate Beam ID 1 may be selected corresponding to the highest priority and best measured PRS RSRP. Alternatively, the measured RSRP may correspond to a non-PRS RS.

In various embodiments, in the event that network configured lower priority beams have a stronger RSRP (e.g., beam candidate 3 is measured to be −80 dBm in FIG. 5), a UE may choose priority indication over beam strength.

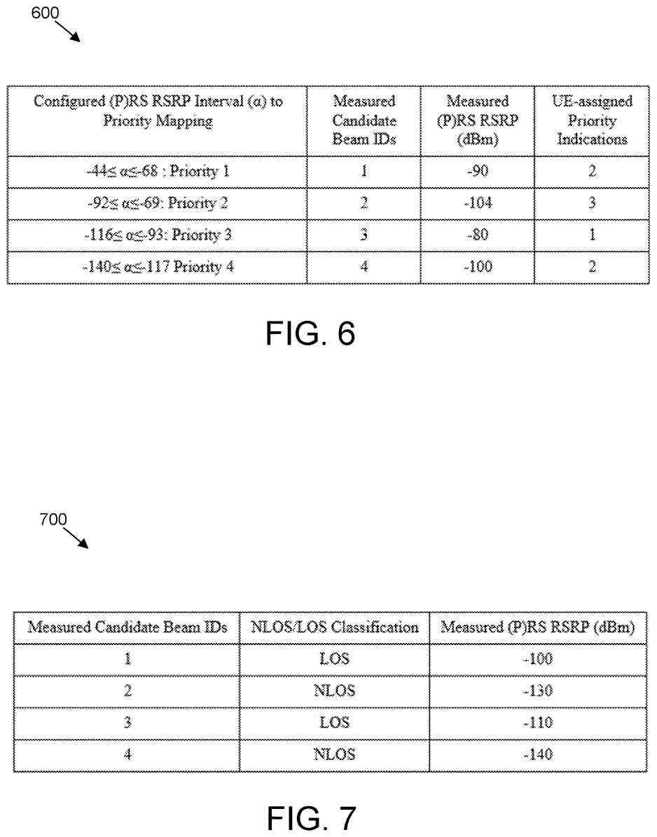

FIG. 6 illustrates one representation of a table 600 of UE-based configured priority-based criterion for selecting a next available beam. In some embodiments, a UE may perform prioritization using a configured UE-based rule that compares a measured PRS RSRP or non-PRS RSRP (collectively referred to as “(P)RS RSRP”) against a configured (P)RS RSRP (α) interval and then dynamically assigns a priority for reselection and switching, e.g., as shown in FIG. 6. In such embodiments, candidate beam 3 may be selected based on a UE-assigned priority. In various embodiments, there may be a configured (P)RS RSRP interval (α)-to-priority mapping. The configured (P)RS RSRP interval (α) to priority mapping may be configured or preconfigured to a UE using LPP and/or RRC signaling. Accordingly, the table 600 illustrates one embodiment of a UE-based measured candidate-beam list and/or index using the UE-based configured priority-based criterion.

In certain embodiments, a network configured priority may be configured by a gNB (e.g., via downlink control information (“DCI”), RRC) or LMF (e.g., via LPP) and may be based on a variety of factors such as available PRS resource bandwidth which may directly impact a location estimation accuracy or a type of location request based on positioning application service requirements.

In some embodiments, a network may assign a priority based on a latency requirement of a particular service and/or use and/or in combination with a required horizontal accuracy, vertical accuracy, heading, and/or velocity of a UE. The priority may be signaled using layer-2 assistance data signaling (e.g., based on positioning system information) associated with a positioning-related measurement (e.g., LPP, RRC) or layer-1 priority indications (e.g., using DCI). The network may assign priority indications and/or a (P)RS RSRP interval-to-priority mapping in FIG. 5 and FIG. 6 based on one or more of the following combination of positioning performance indicators: 1) a delay budget of a positioning service and/or use or latency requirements (e.g., time to first fix (“TTFF”)); 2) horizontal accuracy and/or vertical accuracy requirements; 3) a velocity requirement of a UE; 4) a heading requirement of the UE; 5) a positioning error after an initial UE position estimate calculation; and/or 6) service level requirements.

In various embodiments, on a physical layer, priority indications may correspond to a specific set of DL or UL positioning-related signals (e.g., PRS and/or sounding reference signal (“SRS”) resource ID, PRS and/or SRS resource set, TRP-ID and/or DL-PRS-ID associated with a PRS and/or SRS resource and/or resource set.

In certain embodiments, a priority indication enables a UE to perform low latency positioning through dynamic reselection and/or switching of beams to perform positioning-related measurements and avoid traditional beam reselection procedures in the event of beam failure, NLOS classification, or lack of any LOS beams. In such embodiments, the UE may avoid notifying a location server of such events and may therefore decrease signaling overhead and delay of such notifications.

In some embodiments, a rapid selection and switching mechanism may be enabled using a LOS and/or NLOS criterion.

FIG. 7 illustrates one representation of a table 700 of LOS and/or NLOS identification of beam candidates. In some embodiments, a wireless network may support a method for allowing a UE to rapidly reselect or switch to a next available beam from a configured or preconfigured beam-candidate list may be used. The UE's rapid selection and switching mechanism may be based on an a priori and/or earlier LOS and/or NLOS identification of beam candidates, e.g., as shown in FIG. 7. Specifically, the table 700 illustrates one embodiment of a UE-based measured candidate-beam list and/or index using an LOS and/or NLOS identification.

In certain embodiments, since NLOS degrades positioning performance, available LOS beam pairs may be exploited to recover positioning performance or increase accuracy of a UE estimate based on corresponding positioning measurements. In such embodiments, candidate beams may be classified based on state-of-the-art NLOS identification techniques such as hypothesis testing, machine learning techniques using feature extraction, root means squared (“RMS”) delay spread, amplitude, range estimates, and so forth. Some embodiments of LOS and/or NLOS classification may be based upon a threshold function (β) which may include a combination of features such as signal standard deviation and mean, signal kurtosis, skewness, Rician K-factor, and/or goodness of fit. In various embodiments, a beam may be classified as LOS and/or NLOS by exceeding and/or not exceeding a configured threshold β.

In certain embodiments, upon detection of an NLOS beam, a UE may autonomously switch to a more suitable LOS beam based on a measured candidate-beam list and/or index in FIG. 7 (e.g., candidate beam ID 1 may meet the aforementioned criteria for switching due to a stronger (P)RS RSRP than candidate beam ID 3 which has been classified as LOS.

In various embodiments, an LOS and/or NLOS indication enables a UE to discard or not consider beams containing positioning-related measurements which have been deemed to be NLOS. Avoiding NLOS beams may increase an overall positioning accuracy performance.

In certain embodiments, a rapid selection and switching mechanism may enable using a UE positioning error.

In some embodiments, a UE may rapidly select a beam from a configured beam-candidate list of a single TRP depending on a positioning error (e.g., integrity of a position estimate based on a confidence level) calculated at the UE or a location server. The positioning error may be defined by a difference between the UE's true position and an estimated position. In one embodiment, if a positioning error of a UE's estimated position is below a required accuracy mentioned in a request, then the UE may rapidly select another beam containing PRS resources from a configured candidate beam list. In another embodiment, a UE does not need to perform reselection of a beam even if any RSRP of the beam is below a configured interval or threshold value unless a positioning error is above a certain threshold.

In various embodiments, configuration for threshold values may be provided for each positioning method.

In certain embodiments, configuration of a threshold value for each positioning method may be provided to a UE. For example, if a UE measures a PRS resource from beam 1 using TDOA and if an RSRP measured from beam 1 is below a certain configured threshold for good TDOA estimate, then the UE may dynamically calculate its position estimate using another positioning method for this PRS resource (e.g., based on a UE-based positioning mechanism) and inform a gNB and/or LPP, or the UE may indicate to the gNB and/or LMF to modify the positioning method based on real-time conditions at the UE.

In some embodiments, a gNB may dynamically update a transmission configuration indicator (“TCI”) state and/or quasi-co-location (“QCL”) assumption of a beam transmitting PRS resource within the PRS transmission occasion if a measured RSRP is below a certain configured threshold or an estimated positioning does not fulfill a positioning accuracy required by a location server (e.g., LMF) or a UE.

In various embodiments, a UE's positioning may be estimated from a PRS resource transmitted from one or more TRPs and/or beams if the measured PRS RSRP is below a certain configured threshold value.

In certain embodiments, one or more combinations of embodiments described herein may be combined. In some embodiments, switching between carriers or an addition of carriers within a PRS transmission occasion or reporting may be performed.

In various embodiments, a UE may signal: 1) an LMF (e.g., via LPP); or 2) a gNB (e.g., via uplink control information (“UCI”), RRC) to signal the LMF (e.g., via NR positioning protocol annex (“NRPPa”)) to update its UE positioning configuration based on a dynamic beam reselection and/or switching associated with various embodiments (e.g., if a positioning-related RS measurement is below a certain threshold or identified as NLOS and not deemed suitable for a desired accuracy).

In certain embodiments, two-level switching criteria for fast TRP switching may be used within candidate beams of different TRPs or sets of TRPs.

In some embodiments, a fast and/or rapid switching for beam-candidates belonging to different TRPs may be used and may serve as an extension to other embodiments. If all the beams for a TRP are exhausted or deemed not suitable for PRS measurement, lack any PRS configuration measurements, or have LOS unavailability, a UE may perform one of the following for rapid reselection: 1) switch to another beam from a beam-candidate list of another TRP based on different criteria; 2) switch to a beam of another TRP within a set of TRP candidates which are prioritized based on a network configured TRP priority indication; and/or 3) switch to a configured default beam of another TRP within a set of TRP candidates.

In various embodiments, different TRPs or sets of TRPs may belong to a serving gNB or neighboring gNBs in a vicinity of the UE's location. If the available TRPs are also from neighboring gNBs, then an RSRP of PRS resources may be a prioritized RS measurement (e.g., beams from neighboring cells containing positioning-related RS resources may be prioritized). A serving gNB may obtain area beam information from a network entity, such as the LMF, or along an Xn interface which connects the serving gNB with other neighboring gNBs. The area beam information includes an index of different beam-candidate lists from different gNBs and/or TRPs.

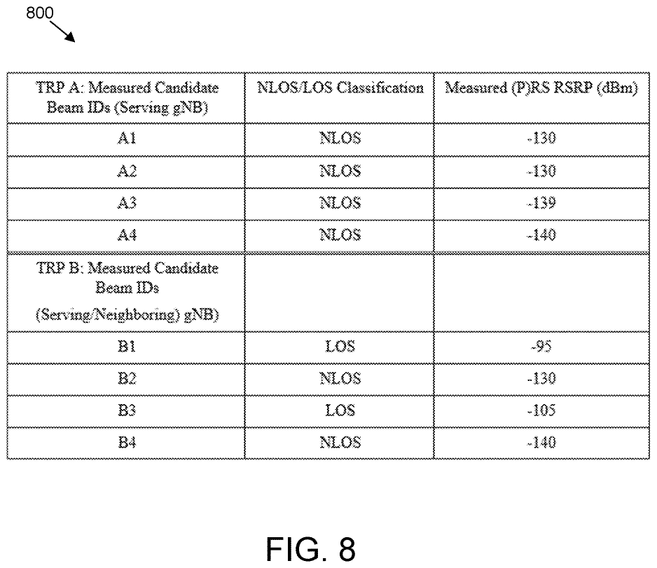

FIG. 8 illustrates an exemplary representation of a table 800 for a two-level switching and/or reselection mechanism using LOS and/or NLOS identification criteria. In certain embodiments, a candidate beam ID B1 from TRP B is selected as a most appropriate beam for rapid switching. In some embodiments, a default beam may be configured among a set of beam candidates B1-B4 from TRP B. The default beam may be used to perform rapid reselection and/or switching. In various embodiments, a set of TRP candidates and/or candidate beams associated with DL PRS resources may have the same DL PRS positioning frequency layer configuration (e.g., subcarrier spacing, cyclic prefix, point A—the absolute frequency of the lowest subcarrier of a reference resource block). Specifically, the table 800 illustrates one embodiment rapid switching between different TRPs. As may be appreciated, any embodiments described herein may be used in conjunction with each other to perform rapid beam switching of a beam pair.

In certain embodiments, NLOS beam detection may include no LOS measurements with a spatial relation and/or setting with a source RS (e.g., SSB or DL PRS) that is QCL Type-D with a target RS (e.g., DL PRS of a DL PRS resource) corresponding to the beam. The NLOS beam detection may be identified (e.g., metrics distinguishing LOS and NLOS) based on one or more channel characteristics (e.g., received signal power, features extracted from channel power delay profile) received signal antenna array based techniques (e.g., received signal phase difference between antenna ports, AoA and/or AoD measurements), time of arrival (“TOA”) measurements, consistency between different measurements (e.g., TOA and path loss measurements, consistency between direction and/or angle of departure and direction and/or angle of arrival).

In some embodiments, beam failure detection may be based on a quality of a beam and/or radio link (e.g., based on RSRP measurement on a beam failure detection RS (“BFD-RS”) as compared to a threshold or within an interval, a quality of BFD-RS as compared against a threshold level at which a DL radio level link of a given BFD-RS resource cannot be reliably received and can correspond to X % (e.g., X=10%) block error rate of a hypothetical physical downlink control channel (“PDCCH”) transmission. The BFD-RS may be a DL PRS or a source RS (e.g., SSB) that is quasi co-located (e.g., QCL Type-D) with the DL PRS. In various embodiments, an X % block error rate (“BLER”) of a hypothetical PDCCH may be used to evaluate a quality of a beam link only for beams belonging to a serving cell (or gNB) and not for neighbor cells (or gNBs).

In various embodiments, a number of instance indication of beam failure and/or NLOS beam detection may be counted while a timer is running (e.g., with the timer started or restarted at each beam failure and/or NLOS beam detection instance indication-the value of the timer may be configured by a network) and, if the instance counter reaches a threshold (e.g., maximum value configured by the network), the UE may switch and reselect between beams for positioning related measurements. The instance indication of whether a beam failure and/or NLOS beam is detected may be determined with a certain periodicity (e.g., based on the periodicity of the PRS or BFD-RS, or configured by the network).

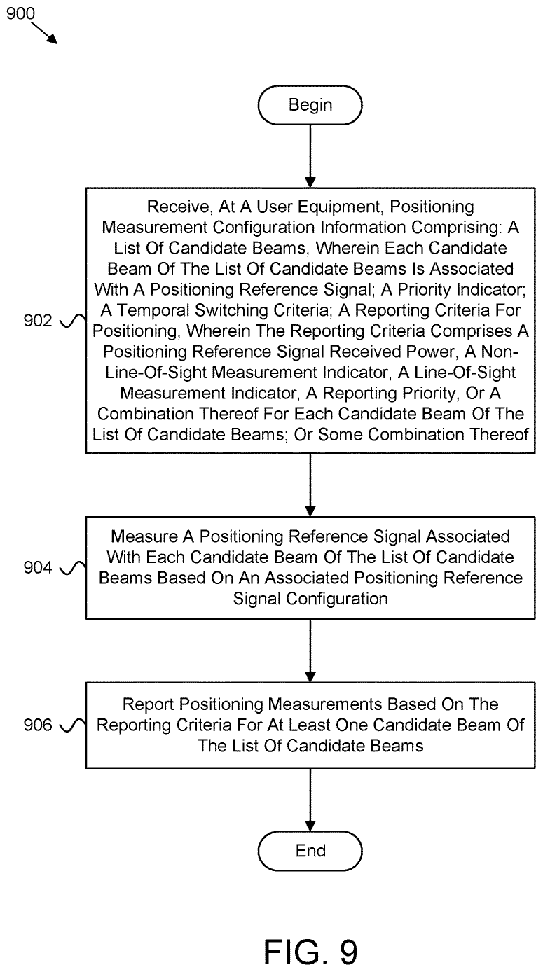

FIG. 9 is a flow chart diagram illustrating one embodiment of a method 900 for reporting positioning measurements. In some embodiments, the method 900 is performed by an apparatus, such as the remote unit 102. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902, at a user equipment, positioning measurement configuration information including: a list of candidate beams, wherein each candidate beam of the list of candidate beams is associated with a positioning reference signal; a priority indicator; a temporal switching criteria; and/or a reporting criteria for positioning. The reporting criteria includes a positioning reference signal received power, an NLOS measurement indicator, a LOS measurement indicator, and/or a reporting priority for each candidate beam of the list of candidate beams. In some embodiments, the method 900 includes measuring 904 a positioning reference signal associated with each candidate beam of the list of candidate beams based on an associated positioning reference signal configuration. In certain embodiments, the method 900 includes reporting 906 positioning measurements based on the reporting criteria for at least one candidate beam of the list of candidate beams.

In certain embodiments, receiving the positioning measurement configuration information may include receiving the positioning measurement configuration information from a location server via a long term evolution positioning protocol. In some embodiments, receiving the positioning measurement configuration information may include retrieving the positioning measurement configuration information from a stored preconfigured information set. In various embodiments, the reporting priority is associated with a DL positioning-related signal, a UL positioning-related signal, a DL positioning-related signal identifier, a UL positioning-related signal identifier, a PRS identifier, a sounding reference signal identifier, a positioning reference signal resource set, a sounding reference signal resource set, a transmission and reception point identifier, or some combination thereof.

In one embodiment, the method 900 may further include selecting a beam for reporting from the list of candidate beams based on the temporal switching criteria. In certain embodiments, the beam for reporting may include a beam from a transmission and reception point within a set of transmission and reception points distinct from a currently received beam, and each transmission and reception point of the set of transmission and reception points maps to a priority indication. In some embodiments, the reporting priority may include a network configured priority transmitted as assistance data by a location server using a long term evolution positioning protocol.

In various embodiments, the positioning measurement configuration information is associated with a prior initiation of a location request or a long term evolution positioning protocol session. In one embodiment, the method 900 may further include transmitting the list of candidate beams to the location server as assistance information, wherein the list of candidate beams may include at least one candidate beam related positioning reference signal measurement, such as a positioning reference signal received power, an NLOS measurement indicator, a LOS measurement indicator, or a combination thereof.

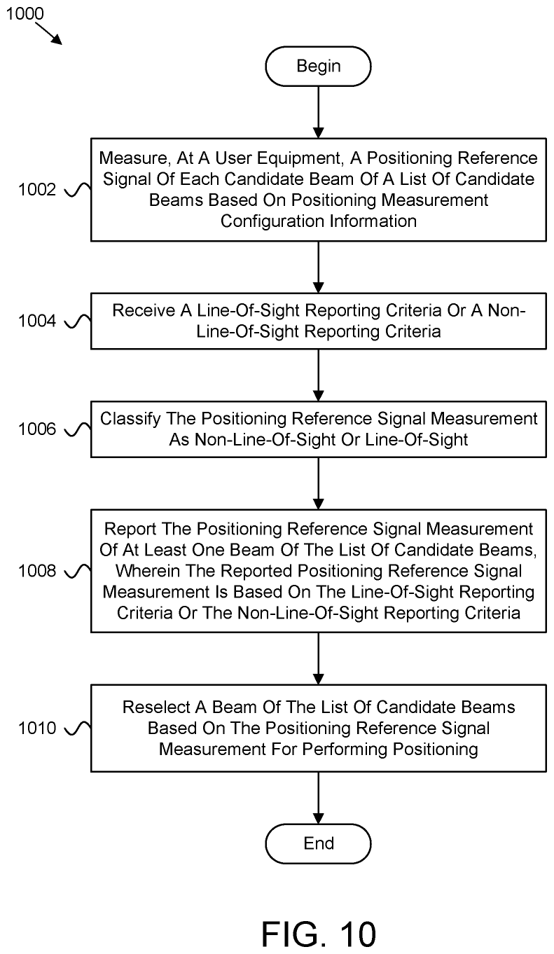

FIG. 10 is a flow chart diagram illustrating one embodiment of a method 1000 for reporting positioning measurements. In some embodiments, the method 1000 is performed by an apparatus, such as the remote unit 102. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes measuring 1002, at a user equipment, a positioning reference signal of each candidate beam of a list of candidate beams based on positioning measurement configuration information. In certain embodiments, the method 1000 includes receiving 1004 a LOS reporting criteria or an NLOS reporting criteria. In various embodiments, the method 1000 includes classifying 1006 the positioning reference signal measurement as NLOS or LOS. In some embodiments, the method 1000 includes reporting 1008 the positioning reference signal measurement of at least one beam of the list of candidate beams. The reported positioning reference signal measurement is based on the LOS reporting criteria or the NLOS reporting criteria. In certain embodiments, the method 1000 includes reselecting 1010 a beam of the list of candidate beams based on the positioning reference signal measurement for performing positioning.

In certain embodiments, classifying the positioning reference signal measurement as LOS or NLOS is based on a received metric distinguishing LOS or NLOS beam positioning reference signal measurement. In some embodiments, the positioning reference signal measurement may include a received signal power, features extracted from a channel power delay profile, a received signal phase difference between antenna ports, a time-of-arrival, a pathloss measurement, or a combination thereof. In various embodiments, the method 1000 may further include reporting at least one NLOS beam or at least one LOS beam associated with the positioning reference signal measurement.

In one embodiment, classifying the positioning reference signal measurement may include determining an NLOS beam or a LOS beam based on a predetermined time interval. In certain embodiments, the predetermined time interval may include a short-term change in a radio environment, a medium-term change in the radio environment, or a long-term change in the radio environment. In some embodiments, the predetermined time interval is activated via a physical layer, configured via RRC signaling, a long term evolution positioning protocol, or a combination thereof.

In various embodiments, classifying the positioning reference signal measurement may include determining an NLOS beam or a LOS beam based on a predetermined function, a predetermined threshold, or a combination thereof. In one embodiment, the predetermined function may include a signal standard deviation, a signal mean, a signal kurtosis, a skewness, a Rician K-factor, a goodness of fit, or some combination thereof. In certain embodiments, the predetermined threshold may include a hypothesis test, a root mean square delay spread, an amplitude, a range estimate, or some combination thereof. In some embodiments, reporting the positioning reference signal measurement of the at least one beam may include reporting a set of LOS only measurement indicators, a set of NLOS only measurement indicators, or a combination thereof.

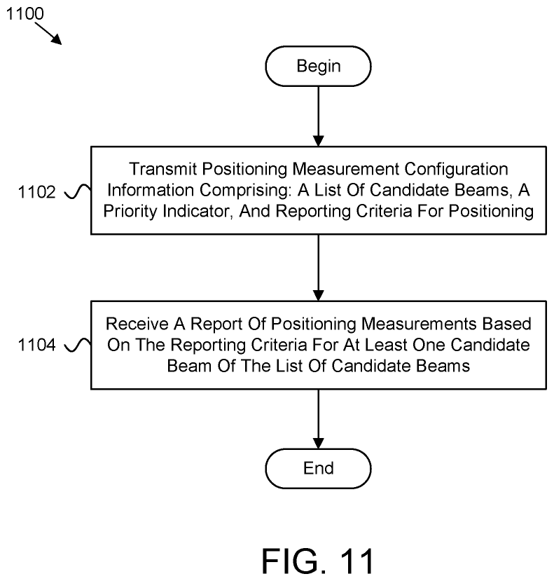

FIG. 11 is a flow chart diagram illustrating one embodiment of a method 1100 for requesting positioning measurements. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes transmitting 1102 positioning measurement configuration information including a list of candidate beams, a priority indicator, and reporting criteria for positioning. Each candidate beam of the list of candidate beams may be associated with a PRS. The reporting criteria for positioning may include an NLOS measurement indicator, a LOS measurement indicator, and a reporting priority for each candidate beam of the list of candidate beams. In various embodiments, the method includes receiving 1104 a report of positioning measurements based on the reporting criteria for at least one candidate beam of the list of candidate beams. The positioning measurements may be based on PRSs associated with at least one candidate beam of the list of candidate beams based on an associated PRS configuration.

In certain embodiments, the method 1100 may further include transmitting the positioning measurement configuration information to a UE via an LPP. In some embodiments, the reporting priority is associated with one or more of a DL positioning-related signal, a UL positioning-related signal, a DL positioning-related signal ID, a UL positioning-related signal ID, a PRS ID, an SRS ID, a PRS resource set, an SRS resource set, or a TRP ID. In various embodiments, the report of positioning measurements is received via a beam from the list of candidate beams based on at least one temporal switching criterion.

In certain embodiments, the beam for the report of positioning measurements includes a beam from a TRP within a set of TRPs distinct from a currently received beam, and each TRP of the set of TRPs maps to a priority indication. In some embodiments, the reporting priority may include a network configured priority transmitted as assistance data to a UE via an LPP. In various embodiments, the method 1100 may further include receiving the list of candidate beams from a UE as assistance information, where the list of candidate beams may include at least one candidate beam related PRS measurement, the at least one candidate beam related PRS measurement may include one or more of a PRS received power, an NLOS measurement indicator, or a LOS measurement indicator. In various embodiments, the method 1100 is performed by a base station or an LMF.

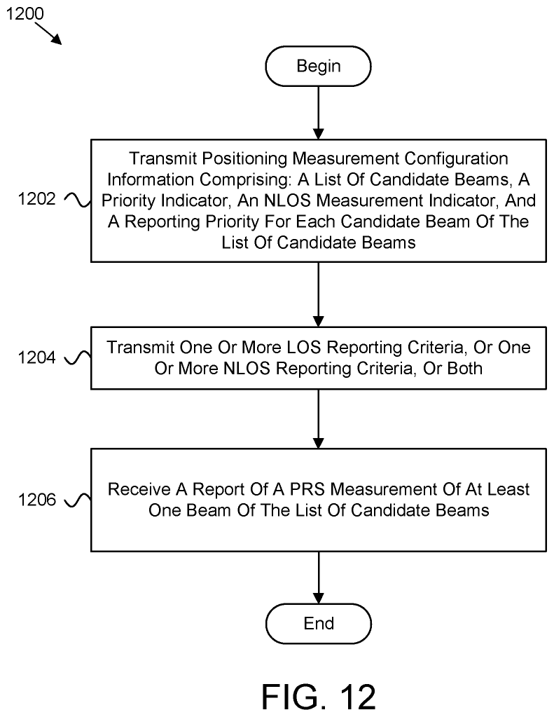

FIG. 12 is a flow chart diagram illustrating another embodiment of a method 1200 for requesting positioning measurements. In some embodiments, the method 1200 is performed by an apparatus, such as the network unit 104. In certain embodiments, the method 1200 may be performed by a processor executing program code, for example, a microcontroller, a microprocessor, a CPU, a GPU, an auxiliary processing unit, a FPGA, or the like.

In some embodiments, the method 1200 includes transmitting 1202 positioning measurement configuration information including a list of candidate beams, a priority indicator, an NLOS measurement indicator, a LOS measurement indicator, and a reporting priority for each candidate beam of the list of candidate beams. Each candidate beam of the list of candidate beams may be associated with a PRS. The method 1200 may include transmitting 1204 one or more LOS reporting criteria, or one or more NLOS reporting criteria, or both. The method 1200 may include receiving 1206 a report of a PRS measurement of at least one beam of the list of candidate beams. The reported PRS measurement may be based on the LOS reporting criteria or the NLOS reporting criteria. The PRS measurement of at least one beam of the list of candidate beams may be based on the positioning measurement configuration information. The report may further indicate whether the PRS measurement is classified as non LOS or LOS by a UE.

In certain embodiments, the method 1200 may further include transmitting a metric distinguishing LOS or NLOS beam PRS measurement, where the PRS measurement is classified as LOS or NLOS based on the metric. In various embodiments, the PRS measurement includes one or more of a received signal power, features extracted from a channel power delay profile, a received signal phase difference between antenna ports, a time-of-arrival, or a pathloss measurement. In some embodiments, the method 1200 may further include receiving a report of at least one NLOS beam or at least one LOS beam associated with the PRS measurement. In certain embodiments, the PRS measurement is classified by determining an NLOS beam or a LOS beam based on a predetermined time interval. In various embodiments, the predetermined time interval includes a short-term change in a radio environment, a medium-term change in the radio environment, or a long-term change in the radio environment. In some embodiments, the predetermined time interval is one or more of activated via a physical layer, configured via RRC signaling, or an LPP. In certain embodiments, the PRS measurement is classified by determining an NLOS beam or a LOS beam based on one or more of a predetermined function or a predetermined threshold. In various embodiments, the predetermined function includes one or more of a signal standard deviation, a signal mean, a signal kurtosis, a skewness, a Rician K-factor, or a goodness of fit. In some embodiments, the predetermined threshold includes one or more of a hypothesis test, a root mean square delay spread, an amplitude, or a range estimate. In various embodiments, the report of the PRS measurement of the at least one beam may include one or more of a set of LOS only measurement indicators, a set of NLOS only measurement indicators, or a combination thereof.

Described herein is a first method for reporting positioning measurements. The first method may be performed by a UE, such as the remote unit 102, or the apparatus 200, as described herein. In one embodiment, the first method may include: receiving, at a user equipment, positioning measurement configuration information comprising: a list of candidate beams, wherein each candidate beam of the list of candidate beams is associated with a positioning reference signal; a priority indicator; a temporal switching criteria; and a reporting criteria for positioning, wherein the reporting criteria may include a positioning reference signal received power, an NLOS measurement indicator, a LOS measurement indicator, a reporting priority, or a combination thereof for each candidate beam of the list of candidate beams; or some combination thereof; measuring a positioning reference signal associated with each candidate beam of the list of candidate beams based on an associated positioning reference signal configuration; and reporting positioning measurements based on the reporting criteria for at least one candidate beam of the list of candidate beams.

In certain embodiments, receiving the positioning measurement configuration information may include receiving the positioning measurement configuration information from a location server via a long term evolution positioning protocol.

In some embodiments, receiving the positioning measurement configuration information may include retrieving the positioning measurement configuration information from a stored preconfigured information set.

In various embodiments, the reporting priority is associated with a DL positioning-related signal, a UL positioning-related signal, a DL positioning-related signal identifier, a UL positioning-related signal identifier, a PRS identifier, a sounding reference signal identifier, a positioning reference signal resource set, a sounding reference signal resource set, a transmission and reception point identifier, or some combination thereof.

In one embodiment, the first method may further include selecting a beam for reporting from the list of candidate beams based on the temporal switching criteria.

In certain embodiments, the beam for reporting may include a beam from a transmission and reception point within a set of transmission and reception points distinct from a currently received beam, and each transmission and reception point of the set of transmission and reception points maps to a priority indication.

In some embodiments, the reporting priority may include a network configured priority transmitted as assistance data by a location server using a long term evolution positioning protocol.

In various embodiments, the positioning measurement configuration information is associated with a prior initiation of a location request or a long term evolution positioning protocol session.

In one embodiment, the first method further may include transmitting the list of candidate beams to the location server as assistance information, wherein the list of candidate beams may include at least one candidate beam related positioning reference signal measurement, such as a positioning reference signal received power, an NLOS measurement indicator, a LOS measurement indicator, or a combination thereof.

Described herein is a first apparatus for reporting positioning measurements. The first apparatus may be performed by a UE, such as the remote unit 102, or the apparatus 200, as described herein. In one embodiment, the first apparatus comprises a UE. The first apparatus further may include: a receiver that receives positioning measurement configuration information comprising: a list of candidate beams, wherein each candidate beam of the list of candidate beams is associated with a positioning reference signal; a priority indicator; a temporal switching criteria; and a reporting criteria for positioning, wherein the reporting criteria may include a positioning reference signal received power, an NLOS measurement indicator, a LOS measurement indicator, a reporting priority, or a combination thereof for each candidate beam of the list of candidate beams; or some combination thereof; and a processor that: measures a positioning reference signal associated with each candidate beam of the list of candidate beams based on an associated positioning reference signal configuration; and reports positioning measurements based on the reporting criteria for at least one candidate beam of the list of candidate beams.

In certain embodiments, the receiver receiving the positioning measurement configuration information may include the receiver receiving the positioning measurement configuration information from a location server via a long term evolution positioning protocol.

In some embodiments, the receiver receiving the positioning measurement configuration information may include the processor retrieving the positioning measurement configuration information from a stored preconfigured information set.

In various embodiments, the reporting priority is associated with a DL positioning-related signal, a UL positioning-related signal, a DL positioning-related signal identifier, a UL positioning-related signal identifier, a positioning reference signal identifier, a sounding reference signal identifier, a positioning reference signal resource set, a sounding reference signal resource set, a transmission and reception point identifier, or some combination thereof.

In one embodiment, the processor selects a beam for reporting from the list of candidate beams based on the temporal switching criteria.

In certain embodiments, the beam for reporting may include a beam from a transmission and reception point within a set of transmission and reception points distinct from a currently received beam, and each transmission and reception point of the set of transmission and reception points maps to a priority indication.

In some embodiments, the reporting priority may include a network configured priority transmitted as assistance data by a location server using a long term evolution positioning protocol.

In various embodiments, the positioning measurement configuration information is associated with a prior initiation of a location request or a long term evolution positioning protocol session.

In one embodiment, the first apparatus further may include a transmitter that transmits the list of candidate beams to the location server as assistance information, wherein the list of candidate beams may include at least one candidate beam related positioning reference signal measurement, such as a positioning reference signal received power, an NLOS measurement indicator, a LOS measurement indicator, or a combination thereof.

Described herein is a second method for reporting positioning measurements. The second method may be performed by a UE, such as the remote unit 102, or the apparatus 200, as described herein. In one embodiment, the second method includes measuring, at a user equipment, a positioning reference signal of each candidate beam of a list of candidate beams based on positioning measurement configuration information; receiving a LOS reporting criteria or an NLOS reporting criteria; classifying the positioning reference signal measurement as NLOS or LOS ; reporting the positioning reference signal measurement of at least one beam of the list of candidate beams, wherein the reported positioning reference signal measurement is based on the LOS reporting criteria or the NLOS reporting criteria; and reselecting a beam of the list of candidate beams based on the positioning reference signal measurement for performing positioning.

In certain embodiments, classifying the positioning reference signal measurement as LOS or NLOS is based on a received metric distinguishing LOS or NLOS beam positioning reference signal measurement.

In some embodiments, the positioning reference signal measurement may include a received signal power, features extracted from a channel power delay profile, a received signal phase difference between antenna ports, a time-of-arrival, a pathloss measurement, or a combination thereof.

In various embodiments, the second method further may include reporting at least one NLOS beam or at least one LOS beam associated with the positioning reference signal measurement.

In one embodiment, classifying the positioning reference signal measurement may include determining an NLOS beam or a LOS beam based on a predetermined time interval.

In certain embodiments, the predetermined time interval may include a short-term change in a radio environment, a medium-term change in the radio environment, or a long-term change in the radio environment.

In some embodiments, the predetermined time interval is activated via a physical layer, configured via RRC signaling, a long term evolution positioning protocol, or a combination thereof.

In various embodiments, classifying the positioning reference signal measurement may include determining an NLOS beam or a LOS beam based on a predetermined function, a predetermined threshold, or a combination thereof.

In one embodiment, the predetermined function may include a signal standard deviation, a signal mean, a signal kurtosis, a skewness, a Rician K-factor, a goodness of fit, or some combination thereof.

In certain embodiments, the predetermined threshold may include a hypothesis test, a root mean square delay spread, an amplitude, a range estimate, or some combination thereof.

In some embodiments, reporting the positioning reference signal measurement of the at least one beam may include reporting a set of LOS only measurement indicators, a set of NLOS only measurement indicators, or a combination thereof.

Described herein is a second apparatus for reporting positioning measurements. The second apparatus may be performed by a UE, such as the remote unit 102, or the apparatus 200, as described herein. In one embodiment, the second apparatus includes a UE. The second apparatus further includes a processor that measures a positioning reference signal of each candidate beam of a list of candidate beams based on positioning measurement configuration information; and a receiver that receives a LOS reporting criteria or an NLOS reporting criteria; wherein the processor: classifies the positioning reference signal measurement as NLOS or LOS ; reports the positioning reference signal measurement of at least one beam of the list of candidate beams, wherein the reported positioning reference signal measurement is based on the LOS reporting criteria or the NLOS reporting criteria; and reselects a beam of the list of candidate beams based on the positioning reference signal measurement for performing positioning.

In certain embodiments, the processor classifies the positioning reference signal measurement as LOS or NLOS based on a received metric distinguishing LOS or NLOS beam positioning reference signal measurement.

In some embodiments, the positioning reference signal measurement may include a received signal power, features extracted from a channel power delay profile, a received signal phase difference between antenna ports, a time-of-arrival, a pathloss measurement, or a combination thereof.

In various embodiments, the processor reports at least one NLOS beam or at least one LOS beam associated with the positioning reference signal measurement.

In one embodiment, the processor classifying the positioning reference signal measurement may include the processor determining an NLOS beam or a LOS beam based on a predetermined time interval.

In certain embodiments, the predetermined time interval may include a short-term change in a radio environment, a medium-term change in the radio environment, or a long-term change in the radio environment.

In some embodiments, the predetermined time interval is activated via a physical layer, configured via RRC signaling, a long term evolution positioning protocol, or a combination thereof.

In various embodiments, the processor classifying the positioning reference signal measurement may include the processor determining an NLOS beam or a LOS beam based on a predetermined function, a predetermined threshold, or a combination thereof.

In one embodiment, the predetermined function may include a signal standard deviation, a signal mean, a signal kurtosis, a skewness, a Rician K-factor, a goodness of fit, or some combination thereof.

In certain embodiments, the predetermined threshold may include a hypothesis test, a root mean square delay spread, an amplitude, a range estimate, or some combination thereof.

In some embodiments, the processor reporting the positioning reference signal measurement of the at least one beam may include the processor reporting a set of LOS only measurement indicators, a set of NLOS only measurement indicators, or a combination thereof.

Described herein is a third method for receiving positioning measurements. The third method may be performed by a UE, such as the remote unit 102, or the apparatus 200, as described herein. In one embodiment, the third method may include transmitting positioning measurement configuration information including a list of candidate beams, a priority indicator, and reporting criteria for positioning. Each candidate beam of the list of candidate beams may be associated with a PRS. The reporting criteria for positioning may include an NLOS measurement indicator, a LOS measurement indicator, and a reporting priority for each candidate beam of the list of candidate beams. The third method may include receiving a report of positioning measurements based on the reporting criteria for at least one candidate beam of the list of candidate beams. The positioning measurements may be based on PRSs associated with at least one candidate beam of the list of candidate beams based on an associated PRS configuration.

In certain embodiments, the third method includes transmitting the positioning measurement configuration information to a UE via an LPP. In some embodiments, the reporting priority is associated with one or more of a DL positioning-related signal, a UL positioning-related signal, a DL positioning-related signal ID, a UL positioning-related signal ID, a PRS ID, an SRS ID, a PRS resource set, an SRS resource set, or a TRP ID. In various embodiments, the report of positioning measurements is received via a beam from the list of candidate beams based on at least one temporal switching criterion.

In certain embodiments, the beam for the report of positioning measurements includes a beam from a TRP within a set of TRPs distinct from a currently received beam, and each TRP of the set of TRPs maps to a priority indication. In some embodiments, the reporting priority may include a network configured priority transmitted as assistance data to a UE via an LPP. In various embodiments, the third method may include receiving the list of candidate beams from a UE as assistance information, where the list of candidate beams may include at least one candidate beam related PRS measurement, the at least one candidate beam related PRS measurement may include one or more of a PRS received power, an NLOS measurement indicator, or a LOS measurement indicator. In various embodiments, the third method may be performed by a base station or an LMF.

Described herein is a third apparatus for receiving positioning measurements. The third apparatus may be performed by a UE, such as the remote unit 102, or the apparatus 200, as described herein. In one embodiment, the third apparatus may include a processor coupled to a memory and configured to cause the network unit to transmit positioning measurement configuration information including a list of candidate beams, a priority indicator, and reporting criteria for positioning. Each candidate beam of the list of candidate beams may be associated with a PRS. The reporting criteria for positioning may include an NLOS measurement indicator, a LOS measurement indicator, and a reporting priority for each candidate beam of the list of candidate beams. The third apparatus may include a processor coupled to a memory and configured to cause the network unit to receive a report of positioning measurements based on the reporting criteria for at least one candidate beam of the list of candidate beams. The positioning measurements may be based on PRSs associated with at least one candidate beam of the list of candidate beams based on an associated PRS configuration.

In certain embodiments, the third apparatus may include a processor coupled to a memory and configured to cause the network unit to transmit the positioning measurement configuration information to a UE via an LPP. In some embodiments, the reporting priority is associated with one or more of a DL positioning-related signal, a UL positioning-related signal, a DL positioning-related signal ID, a UL positioning-related signal ID, a PRS ID, an SRS ID, a PRS resource set, an SRS resource set, or a TRP ID. In various embodiments, the report of positioning measurements is received via a beam from the list of candidate beams based on at least one temporal switching criterion.

In certain embodiments, the beam for the report of positioning measurements includes a beam from a TRP within a set of TRPs distinct from a currently received beam, and each TRP of the set of TRPs maps to a priority indication. In some embodiments, the reporting priority may include a network configured priority transmitted as assistance data to a UE via an LPP. In various embodiments, the third apparatus may include a processor coupled to a memory and configured to cause the network unit to receive the list of candidate beams from a UE as assistance information, where the list of candidate beams may include at least one candidate beam related PRS measurement, the at least one candidate beam related PRS measurement may include one or more of a PRS received power, an NLOS measurement indicator, or a LOS measurement indicator. In various embodiments, the third apparatus may be performed by a base station or an LMF.

Described herein is a fourth method for receiving positioning measurements. The fourth method may be performed by a UE, such as the remote unit 102, or the apparatus 200, as described herein. In one embodiment, the fourth method may include transmitting positioning measurement configuration information including a list of candidate beams, a priority indicator, an NLOS measurement indicator, a LOS measurement indicator, and a reporting priority for each candidate beam of the list of candidate beams. Each candidate beam of the list of candidate beams may be associated with a PRS. The fourth method may include transmitting one or more LOS reporting criteria, or one or more NLOS reporting criteria, or both. The fourth method may include receiving a report of a PRS measurement of at least one beam of the list of candidate beams. The reported PRS measurement may be based on the LOS reporting criteria or the NLOS reporting criteria. The PRS measurement of at least one beam of the list of candidate beams may be based on the positioning measurement configuration information. The report may further indicate whether the PRS measurement is classified as non LOS or LOS by a UE.

In certain embodiments, the fourth method includes transmitting a metric distinguishing LOS or NLOS beam PRS measurement, where the PRS measurement is classified as LOS or NLOS based on the metric. In various embodiments, the PRS measurement includes one or more of a received signal power, features extracted from a channel power delay profile, a received signal phase difference between antenna ports, a time-of-arrival, or a pathloss measurement. In some embodiments, the fourth method includes receiving a report of at least one NLOS beam or at least one LOS beam associated with the PRS measurement.

In certain embodiments, the PRS measurement is classified by determining an NLOS beam or a LOS beam based on a predetermined time interval. In various embodiments, the predetermined time interval includes a short-term change in a radio environment, a medium-term change in the radio environment, or a long-term change in the radio environment. In some embodiments, the predetermined time interval is one or more of activated via a physical layer, configured via RRC signaling, or an LPP. In certain embodiments, the PRS measurement is classified by determining an NLOS beam or a LOS beam based on one or more of a predetermined function or a predetermined threshold.

In various embodiments, the predetermined function includes one or more of a signal standard deviation, a signal mean, a signal kurtosis, a skewness, a Rician K-factor, or a goodness of fit. In some embodiments, the predetermined threshold includes one or more of a hypothesis test, a root mean square delay spread, an amplitude, or a range estimate. In certain embodiments, the report of the PRS measurement of the at least one beam may include one or more of a set of LOS only measurement indicators, a set of NLOS only measurement indicators, or a combination thereof.

Described herein is a fourth apparatus for receiving positioning measurements. The fourth apparatus may be performed by a UE, such as the remote unit 102, or the apparatus 200, as described herein. In one embodiment, the fourth apparatus may include a processor coupled to a memory and configured to cause the network unit to transmit positioning measurement configuration information including a list of candidate beams, a priority indicator, an NLOS measurement indicator, a LOS measurement indicator, and a reporting priority for each candidate beam of the list of candidate beams. Each candidate beam of the list of candidate beams may be associated with a PRS. The fourth apparatus may include a processor coupled to a memory and configured to cause the network unit to transmit one or more LOS reporting criteria, or one or more NLOS reporting criteria, or both. The fourth apparatus may include a processor coupled to a memory and configured to cause the network unit to receive a report of a PRS measurement of at least one beam of the list of candidate beams. The reported PRS measurement may be based on the LOS reporting criteria or the NLOS reporting criteria. The PRS measurement of at least one beam of the list of candidate beams may be based on the positioning measurement configuration information. The report may further indicate whether the PRS measurement is classified as non LOS or LOS by a UE.

In certain embodiments, the fourth apparatus may include a processor coupled to a memory and configured to cause the network unit to transmit a metric distinguishing LOS or NLOS beam PRS measurement, where the PRS measurement is classified as LOS or NLOS based on the metric. In various embodiments, the PRS measurement includes one or more of a received signal power, features extracted from a channel power delay profile, a received signal phase difference between antenna ports, a time-of-arrival, or a pathloss measurement. In some embodiments, the fourth apparatus may include a processor coupled to a memory and configured to cause the base station to receive a report of at least one NLOS beam or at least one LOS beam associated with the PRS measurement. In certain embodiments, the PRS measurement is classified by determining an NLOS beam or a LOS beam based on a predetermined time interval. In various embodiments, the predetermined time interval includes a short-term change in a radio environment, a medium-term change in the radio environment, or a long-term change in the radio environment. In some embodiments, the predetermined time interval is one or more of activated via a physical layer, configured via RRC signaling, or an LPP. In certain embodiments, the PRS measurement is classified by determining an NLOS beam or a LOS beam based on one or more of a predetermined function or a predetermined threshold. In various embodiments, the predetermined function includes one or more of a signal standard deviation, a signal mean, a signal kurtosis, a skewness, a Rician K-factor, or a goodness of fit. In some embodiments, the predetermined threshold includes one or more of a hypothesis test, a root mean square delay spread, an amplitude, or a range estimate. In certain embodiments, the report of the PRS measurement of the at least one beam may include one or more of a set of LOS only measurement indicators, a set of NLOS only measurement indicators, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a network unit, the method comprising:
transmitting positioning measurement configuration information comprising:
a list of candidate beams, wherein each candidate beam of the list of candidate beams is associated with a positioning reference signal (PRS);
a priority indicator; and
reporting criteria for positioning comprising a non-line-of-sight (NLOS) measurement indicator, a line-of-sight (LOS) measurement indicator, and a reporting priority for each candidate beam of the list of candidate beams; and
receiving a report of positioning measurements based on the reporting criteria for at least one candidate beam of the list of candidate beams, wherein the positioning measurements are based on PRSs associated with at least one candidate beam of the list of candidate beams based on an associated PRS configuration.

2. The method of claim 1, further comprising transmitting the positioning measurement configuration information to a user equipment (UE) via a long term evolution (LTE) positioning protocol (LPP).

3. The method of claim 1, wherein the reporting priority is associated with one or more of a downlink (DL) positioning-related signal, an uplink (UL) positioning-related signal, a DL positioning-related signal identifier, a UL positioning-related signal identifier, a PRS identifier, a sounding reference signal (SRS) identifier, a PRS resource set, a SRS resource set, or a transmission and reception point (TRP) identifier (ID).

4. The method of claim 1, wherein the report of positioning measurements is received via a beam from the list of candidate beams based on at least one temporal switching criterion.

5. The method of claim 4, wherein the beam for the report of positioning measurements comprises a beam from a transmission and reception (TRP) point within a set of TRPs distinct from a currently received beam, and each TRP of the set of TRPs maps to a priority indication.

6. The method of claim 1, wherein the reporting priority comprises a network configured priority transmitted as assistance data to a user equipment (UE) via a long term evolution (LTE) positioning protocol (LPP).

7. The method of claim 1, further comprising receiving the list of candidate beams from a user equipment (UE) as assistance information, wherein the list of candidate beams comprises at least one candidate beam related PRS measurement, the at least one candidate beam related PRS measurement comprises one or more of a PRS received power, an NLOS measurement indicator, or a LOS measurement indicator.

8. The method of claim 1, wherein the network unit comprises a base station or a location management function (LMF).

9. A network unit for wireless communication, comprising:
a memory; and
a processor coupled with the memory and configured to cause the network unit to:
transmit positioning measurement configuration information comprising:
a list of candidate beams, wherein each candidate beam of the list of candidate beams is associated with a positioning reference signal (PRS);
a priority indicator; and
reporting criteria for positioning comprising a non-line-of-sight (NLOS) measurement indicator, a line-of-sight (LOS) measurement indicator, and a reporting priority for each candidate beam of the list of candidate beams; and
receive a report of positioning measurements based on the reporting criteria for at least one candidate beam of the list of candidate beams, wherein the positioning measurements are based on PRSs associated with at least one candidate beam of the list of candidate beams based on an associated PRS configuration.

10. A method performed by a network unit, the method comprising:
transmitting positioning measurement configuration information comprising:
a list of candidate beams, wherein each candidate beam of the list of candidate beams is associated with a positioning reference signal (PRS);
a priority indicator;
a non-line-of-sight (NLOS) measurement indicator;
a line-of-sight (LOS) measurement indicator; and
a reporting priority for each candidate beam of the list of candidate beams;
transmitting one or more LOS reporting criteria, or one or more NLOS reporting criteria, or both; and
receiving a report of a PRS measurement of at least one beam of the list of candidate beams, wherein the reported PRS measurement is based on the LOS reporting criteria or the NLOS reporting criteria, wherein the PRS measurement of the at least one beam of the list of candidate beams is based on the positioning measurement configuration information, and wherein the report further indicates whether the PRS measurement is classified as non LOS or LOS by a user equipment (UE).

11. The method of claim 10, further comprising transmitting a metric distinguishing LOS or NLOS beam PRS measurement, wherein the PRS measurement is classified as LOS or NLOS based on the metric.

12. The method of claim 11, wherein the PRS measurement comprises one or more of a received signal power, features extracted from a channel power delay profile, a received signal phase difference between antenna ports, a time-of-arrival, or a pathloss measurement.

13. The method of claim 10, further comprising receiving a report of at least one NLOS beam or at least one LOS beam associated with the PRS measurement.

14. The method of claim 10, wherein the PRS measurement is classified by determining an NLOS beam or a LOS beam based on a predetermined time interval.

15. The method of claim 14, wherein the predetermined time interval comprises a short-term change in a radio environment, a medium-term change in the radio environment, or a long-term change in the radio environment.

16. The method of claim 14, wherein the predetermined time interval is one or more of activated via a physical layer, configured via radio resource control (RRC) signaling, or a long term evolution (LTE) positioning protocol (LPP).

17. The method of claim 10, wherein the PRS measurement is classified by determining an NLOS beam or a LOS beam based on one or more of a predetermined function or a predetermined threshold.

18. The method of claim 17, wherein the predetermined function comprises one or more of a signal standard deviation, a signal mean, a signal kurtosis, a skewness, a Rician K-factor, or a goodness of fit, wherein the predetermined threshold comprises one or more of a hypothesis test, a root mean square delay spread, an amplitude, or a range estimate.

19. The method of claim 10, wherein the report of the PRS measurement of the at least one beam comprises one or more of a set of LOS only measurement indicators, a set of NLOS only measurement indicators, or a combination thereof.

20. A network unit for wireless communication, comprising:
a memory; and
a processor coupled with the memory and configured to cause the network unit to:
transmit positioning measurement configuration information comprising:
a list of candidate beams, wherein each candidate beam of the list of candidate beams is associated with a positioning reference signal (PRS);
a priority indicator;
a non-line-of-sight (NLOS) measurement indicator;
a line-of-sight (LOS) measurement indicator; and
a reporting priority for each candidate beam of the list of candidate beams;
transmit one or more LOS reporting criteria, or one or more NLOS reporting criteria, or both; and
receive a report of a PRS measurement of at least one beam of the list of candidate beams, wherein the reported PRS measurement is based on the LOS reporting criteria or the NLOS reporting criteria, wherein the PRS measurement of the at least one beam of the list of candidate beams is based on the positioning measurement configuration information, and wherein the report further indicates whether the PRS measurement is classified as non LOS or LOS by a user equipment (UE).
